(19) United States
(12) Patent Application Publication
(10) Pub. No.: US 2007/0143303 A1
(43) Pub. Date: Jun. 21, 2007

(54) Method and system for automatically updating software

(75) Inventor: Sung-hyun Cho, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/544,588

(22) Filed: Oct. 10, 2006

(30) Foreign Application Priority Data
Dec. 12, 2005 (KR) 10-2005-0121898

(51) Int. Cl. G06F 17/30

(52) U.S. Cl. 707/10

(57) ABSTRACT

A method and a system for performing automatic software updating capable of efficiently managing update cycles are provided. The method of performing automatic software updating in a client includes requesting information on an update cycle from a server at a check cycle of an update cycle change representing a cycle with which a change of a software update cycle is checked, and receiving the information on the update cycle from the server in response to the request for the information on the update cycle and updating the information on the update cycle of the client.

### CROSS-REFERENCE TO RELATED PATENT APPLICATION

This application claims priority from Korean Patent Application No. 10-2005-0121898, filed on Dec. 12, 2005, in the Korean Intellectual Property Office, the disclosure of which is incorporated herein in its entirety by reference.

### BACKGROUND OF THE INVENTION

1. Field of the Invention

Methods and systems consistent with the present invention relate to automatic software updating, and more particularly, to automatically updating software capable of managing a software update cycle efficiently.

2. Description of Related Art

Currently, software updating is required for consumer electronics (CE) products in addition to personal computers. Since recently announced CE products include a lot of functions, the possibility of having a software bug in these products is increasing, and it is frequently required to add a function to the products or improve an existing function of the products. Accordingly, software updating technologies for the CE products have been actively developed. In addition, technologies for automatically updating software are used for the convenience of users. Since an update cycle for automatically updating software has an important effect on the convenience for users and the performance of a system, a technology for efficiently managing the update cycle is required.

FIG. 1 is a block diagram of a related art method of automatically updating software. In a configuration in which a client receiving a request for software updating and a server delivering required update items to the client are connected through a network, generally a user of the client sets an automatic update cycle (S100). The software updating is performed at the update cycle which is set by the user (S110). The software updating is initiated by the client requesting the server to update software (S112). The server analyzes information included in the request for the software updating, searches for information on the software updating such as a software update item which the client should update (S114), and sends the information on the software updating to the client (S116). The client receiving the information on the software updating, updates installed software using the received information (S118).

As described above, in using the related art method of automatically updating software according to the update cycle set by the user, it is inconvenient for the user to select the update cycle in person. In addition, it is difficult for the user to know what is an adequate update cycle. Moreover, it is inefficient to have the user manage the update cycle for the CE products, since it could be more difficult for the user of the CE products to input the update cycle.

If the update cycle is too long, a necessary update may not be reflected in time. This may cause confusion and is a serious inconvenience especially when the server is required to urgently update software due to a problem such as a software bug, since the server has to wait until the client connects to the server according to the update cycle which is set by the user in order to apply the software updating.

On the other hand, when the update cycle is too short, unnecessary requests for software updating is frequently generated. In this case, even though there is no software update item applicable to a client, the client should send the request for software updating to the server at the update cycle, and the server should process all the received requests for software updating and send results of the process. Accordingly, resources of the client and the server will be wasted. For example, software updating is requested by many clients everyday, resulting in a heavy load on the server.

### SUMMARY OF THE INVENTION

The present invention provides a method and a system for automatically updating software capable of managing an automatic update cycle efficiently according to an environment of a client.

According to an aspect of the present invention, there is provided a method of performing automatic software updating in a client, the method comprising: requesting information on an update cycle to a server at a check cycle on a change in the update cycle in which a change in the update cycle is checked; and receiving the information on the update cycle from the server which is a response to the request for the information on the update cycle and updating the information on the update cycle of the client.

In the aspect above, the method may further comprise: determining whether to perform periodical software updating based on the information on the update cycle of the client; and performing the periodical software updating if it is determined to perform the software updating.

In addition, the method may further comprise, in the performing of the periodical software updating: requesting the server to update software at the update cycle; receiving a software update item from the server which is a response to the request for the software updating; and updating software installed in the client using the received software update item.

According to another aspect of the present invention, there is provided a method of performing automatic software updating, the method in a server supporting automatic software updating of a client comprising: receiving an input of information on an update cycle for a client; receiving a request for information on the update cycle from the client; searching for information on the update cycle for the client from the information on the update cycle for the client; and sending the found information on the update cycle to the client.

According to another aspect of the present invention, there is provided a client for performing automatic software updating comprising: a communication unit which communicates with a server; a storage unit storing information on an update cycle and information on a check cycle on a change in the update cycle; and a control unit requesting the information on the update cycle through the communication unit to the server at the check cycle on the change in the update cycle, storing the information on the update cycle received from the server, and determining whether to perform periodical software updating based on the information on the update cycle.

According to another aspect of the present invention, there is provided a server for supporting automatic software updating of a client comprising: a communication unit which communicates with the client; a storage unit storing information on an update cycle for the client; and a control unit searching for the information on the update cycle for the client in the storage unit and sending the information on the update cycle through the communication unit to the client, if the control unit receives a request for the information on the update cycle. In the aspect above, the information on the update cycle for the client may comprise a longer update cycle than a check cycle on a change in the update cycle of the corresponding client.

In addition, the server for supporting automatic software updating of a client may further comprise an input unit operable to input information, wherein the control unit updates the information on the update cycle for the client which is stored in the storage unit, based on information input through the input unit.

In addition, the information on the software updating for the client may comprise information indicating whether to cancel the automatic software updating for a client for which the software updating is not required.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a related art method of updating software automatically;

FIG. 2 is a block diagram of a method of performing automatic software updating according to an exemplary embodiment of the present invention;

FIG. 3 is a block diagram of a client illustrating a structure of a client of a system for automatically updating software according to an exemplary embodiment of the present invention; and

FIG. 4 is a diagram of a server illustrating a structure of the server according to an exemplary embodiment of the present invention.

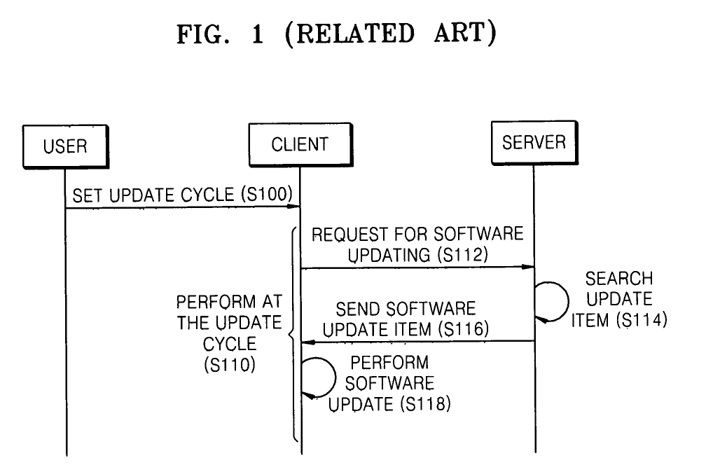

### DETAILED DESCRIPTION OF THE EXEMPLARY EMBODIMENTS

Now, exemplary embodiments of the present invention will be described in detail with reference to the accompanying drawings.

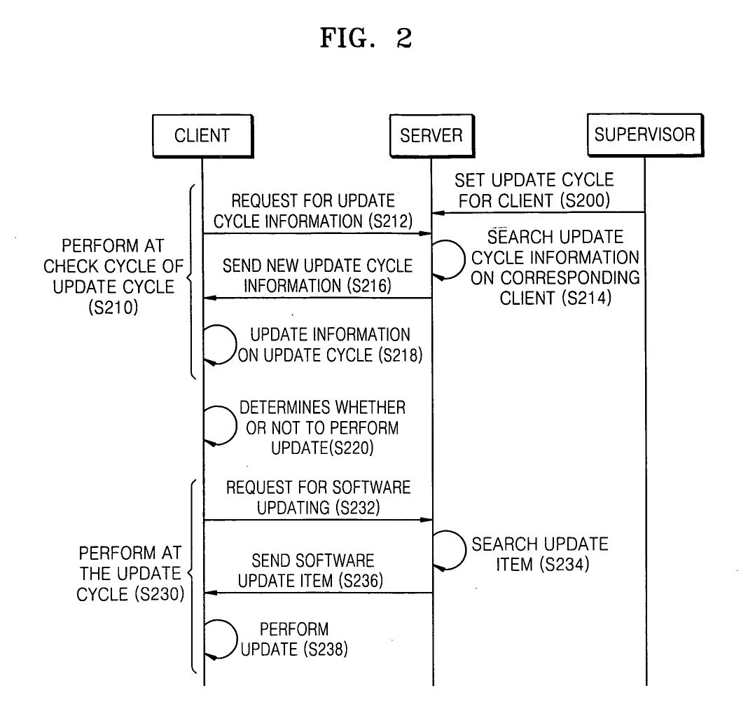

FIG. 2 is a block diagram of a method of performing automatic software updating according to an exemplary embodiment of present invention.

A client according to the exemplary embodiment of the present invention maintains two cycles for automatically updating software. The cycles are an update cycle and a check cycle of a change in the update cycle. The update cycle is a cycle for performing the software updating and has the same concept as a conventional update cycle. The check cycle of the change in the update cycle is a cycle of the client inquiring of the server as to whether the updated cycle has changed. The client respectively sends requests which are different from each other according to the two cycles.

The client checks whether the update cycle has changed at the check cycle of the change in the update cycle (S210). The client requests the server for information on the update cycle for checking the change of the update cycle (S212). Intrinsic information on the client is sent to the server along with the request when requesting the information on the update cycle. The server receiving the request for the information on the update cycle searches for information on a corresponding update cycle of the client based on the intrinsic information on the client (S214) and sends information on a new update cycle to the client (S216). The client receiving the information on the new update cycle updates its update cycle based on the received information on the new update cycle (S218). In other words, when the new update cycle received from the server is different from the existing update cycle, the client stores the new update cycle. The server can manage the update cycles for the clients, respectively. For example, the server can set a different update cycle according to a model, a used language, and a service type of the client which are received along with the request for the information on the update cycle of the client from the client.

The client determines periodically whether or not to update the software based on the update cycle of the client (S220). When the client is not set to perform the automatic software updating periodically, the client does not perform the automatic software updating, and when the update cycle is set to perform the automatic updating periodically, the client updates the software at the update cycle (S230).

A procedure for performing the periodical software updating will be described below. At first, the client sends a request for the software updating, which includes information on the client itself at the update cycle, to the server (S232). The server, which receives the update request, searches for corresponding update items for the client based on the information on the client (S234). In the update items, a list of software programs to be updated by the client and information required to be updated is included. When the server sends the software update items to the client (S236), the client performs the software updating by using the received information from the server (S238).

The check cycle of the change in the update cycle and the update cycle are not related with each other, however, the check cycle of the change in the update cycle may be set for a shorter period of time than the update cycle for efficient operation. For example, when the check cycle of a change in the update cycle is set to one day, and the update cycle is set to one month, the client requests the server for the information on the update cycle information once a day, however the request for the software updating is sent once a month, so that a load on the server can be decreased. When there is an emergent update, the server can shorten the update cycle for enabling the client to apply the software updating immediately. For example, when a software bug in a specific model is found, the server can enable the corresponding clients to perform the software updating sooner by setting the update cycle for the corresponding model to one day.

On the other hand, when the software updating for a product is no longer required since the product was released a long time ago, it can be set not to perform the automatic software updating for the corresponding clients. Of course, the server can send an update cycle to the client, so that the automatic software updating is reinitiated. This update cycle for the client can be managed by an input from a supervisor. In other words, the supervisor inputs different cycles for the clients respectively as is needed (S200) and sends the clients the update cycles input by the supervisor, when the clients request the information on the update cycles (S210).

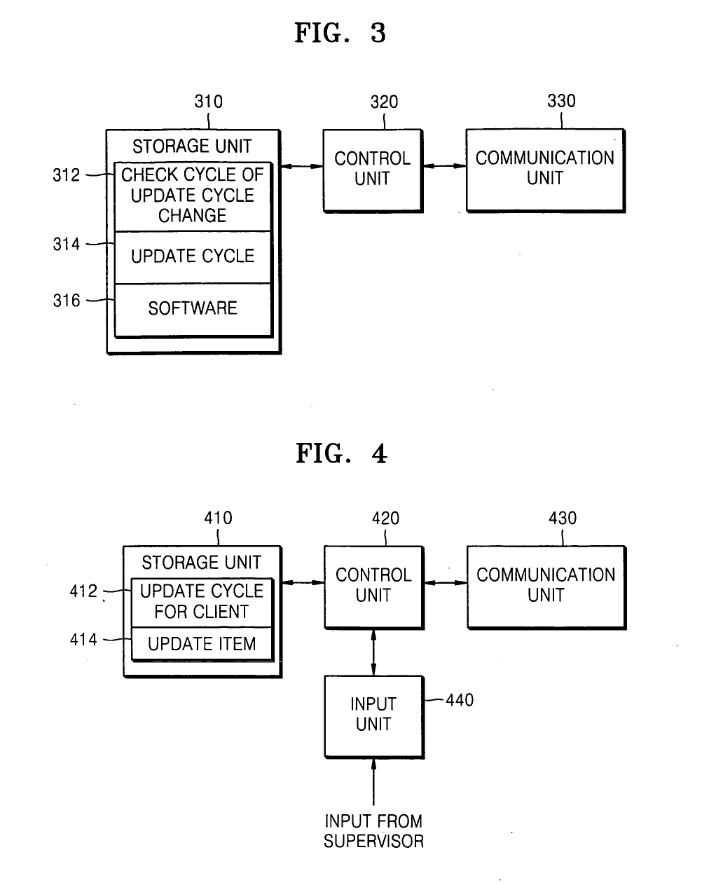

FIG. 3 is a block diagram of a client illustrating a structure of a client of a system for automatically updating software according to the exemplary embodiment of the present invention. Referring to FIG. 3, the client performing automatic software updating includes a storage unit 310, a control unit 320, and a communication unit 330.

The communication unit 330 which is used for communicating with the server sends information to the server and receives information from the server by connecting to a network such as a wireless Internet. The storage unit 310 stores information on the update cycle 314 and information on the check cycle for the change in the update cycle 312. In addition, in the storage unit 310, software 316 which is executable in the client is installed and stored.

The control unit 320 requests the server for the information on the update cycle through the communication unit 330 at the check cycle for the change in the update cycle and stores the information on the update cycle 314 which is received from the server in the storage unit 310. In addition, the control unit 320 determines whether or not to perform periodical software updating based on the update cycle information 314. When the software updating is performed periodically, the software updating is requested to the server through the communication unit 330 at the update cycle which is included in the information on the update cycle 314, the software update items are received through the communication unit 330 from the server, and the software 316 which is installed in the client is updated using the received software update items.

FIG. 4 is a diagram of a server illustrating a structure of a server according to the exemplary embodiment of the present invention. Referring to FIG. 4, the server supporting the automatic software updating of the client includes a storage unit 410, a control unit 420, a communication unit 430, and an input unit 440.

The communication unit 430 which is used for communicating with the client, sends information to the client and receives information from the client. The storage unit 410 stores information on the software updating of the client, such as the information on the update frequency for the client 412 and the software update items 414.

The control unit 420 performs two different types of processes according to the received request from the client. In other words, when the control unit 420 receives a request for the information on the update cycle through the communication unit 430 from the client, the control unit 420 searches for information on the update cycle 412 in the storage unit 410 and sends the information on the update cycle 412 through the communication unit 430 to the corresponding client. When the control unit 420 receives a request for updating software through the communication unit 430 from the client, the control unit 420 searches for the software update items 414 in the storage unit 410 required for the client requesting for updating the software and sends the software update items through the communication unit 430 to the corresponding client.

The input unit 440 is used for inputting information by a supervisor and the supervisor can change the update cycle of the client as desired by the supervisor through the input unit 440. For example, for a client who does not need to update software, information indicating cancellation of the automatic software updating may be input. The control unit 420 updates the information on the update cycle for the client 412 which is stored in the storage unit 410 based on the information input through the input unit 440 and sends a new update cycle to the client when the client requests for the update cycle of the client.

The invention can also be embodied as computer readable codes on a computer readable recording medium.

As described above, according to an exemplary embodiment of the present invention, the server is capable of managing the software update cycles of the clients and it is possible to manage the update cycle according to the client or the type of the client.

The server can lengthen the update cycle of the client as is needed. When there are no emergent update items, or when the possibility of requiring an update is low for a specific client, since an unnecessary update request may be sent when the client has a very short update cycle, the server can lengthen the update cycle when the client requests the information on the update cycle. As a result, connection traffic according to the update request from the client is decreased, system resources required for processing the update request in the server can be saved, and the traffic for sending the result of the update request can be decreased. The server can shorten the update cycle of the client as is needed.

When an emergency update is required for a specific client, according to the conventional technology the server has to wait until the client connects to the server and sends an update request. However, when the information on the update cycle is requested, which occurs frequently, since the update cycle of the client can be shortened in the exemplary embodiment of the present invention, the update can be performed within a short period of time. Since a process for an update request requires far more system resources than a process for a request for information on the update cycle, the exemplary embodiment of the present invention is very efficient in terms of resources.

While the present invention has been particularly shown and described with reference to exemplary embodiments thereof, it will be understood by those skilled in the art that various changes in form and details may be made therein without departing from the spirit and scope of the exemplary embodiments of the present invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. A method of performing automatic software updating in a client, the method comprising:
requesting information on an update cycle from a server; and
receiving the information on the update cycle from the server in response to the request for the information on the update cycle and updating the information on the update cycle of the client.

2. The method of claim 1, wherein the requesting information on the update cycle is performed at a check cycle on a change in the update cycle.

3. The method of claim 1, further comprising:
determining whether to perform periodical software updating based on the information on the update cycle of the client; and
performing the periodical software updating if it is determined to perform the periodical software updating.

4. The method of claim 1, further comprising:
requesting the server to update software at the update cycle;
receiving a software update item from the server in response to the request for the software updating; and
updating software installed in the client using the received software update item.

5. A method of performing automatic software updating, the method in a server supporting automatic software updating of a client, the method comprising:
receiving a request for information on an update cycle from the client;
searching for information on the update cycle for the client; and
sending found information on the update cycle, if the information is found as a result of the searching, to the client.

6. The method of claim 5, wherein the information on the update cycle is updated based on information input by a supervisor.

7. The method of claim 5, further comprising:
receiving a request for updating software from the client;
searching for a corresponding software update item for the client; and
sending the software update item to the client if the software item is found as a result of searching.

8. A client for performing automatic software updating, the client comprising:
a communication unit which communicates with a server;
a storage unit storing information on an update cycle and information on a check cycle on a change in the update cycle; and
a control unit requesting the information on the update cycle through the communication unit from the server at the check cycle on the change in the update cycle, storing the information on the update cycle received from the server to the storage unit, and determining whether to perform periodical software updating based on the information on the update cycle.

9. The client of claim 8, wherein the control unit performing the periodical software updating requests the server to update software through the communication unit at the update cycle, receives a software update item through the communication unit from the server, and updates a software installed in the client using the received update item.

10. A server for supporting automatic software updating of a client, the server comprising:
a communication unit which communicates with the client;
a storage unit which stores information on an update cycle for the client; and
a control unit which searches for the information on the update cycle for the client in the storage unit and sends the information on the update cycle through the communication unit to the client, if the control unit receives a request for the information on the update cycle.

11. The server of claim 8, wherein the storage unit further stores information on a software update item, and
the control unit searches for and sends through the communication unit to the client the software update item for the client, if the control unit receives a request for updating software through the communication unit from the client.

12. The server of claim 11, further comprising an input unit operable to input information,
wherein the control unit updates the information on the update cycle for the client which is stored in the storage unit, based on information input through the input unit.
